(19) United States
(12) Patent Application Publication
(10) Pub. No.: US 2003/0166390 A1
(43) Pub. Date: Sep. 4, 2003

(54) Pedestal

(76) Inventors: Gordon Robert Green, Bristol (GB); Robert Kenneth Trowell, Bristol (GB)

Correspondence Address: VOLENTINE FRANCOS, P.L.L.C., 12200 Sunrise Valley Drive, Suite 150, Reston, VA, 20191, US

(21) Appl. No.: 10/373,768

(22) Filed: Feb. 27, 2003

Related U.S. Application Data
(60) Provisional application No. 60/391,973, filed on Jun. 28, 2002.

(30) Foreign Application Priority Data
Mar. 1, 2002 (GB) 0204882.5

(51) Int. Cl. B01L 1/04; E04B 1/00; E04B 5/00; E04B 7/00; F16M 5/00

(52) U.S. Cl. 454/187; 52/263; 248/637

(57) ABSTRACT

A pedestal for mounting semiconductor fabrication equipment within a clean room. The pedestal includes a base frame sitting on a waffle slab and utility connections. The equipment can readily be connected to the utility connections when positioned on the pedestal. The utility connections are located at the periphery of or across part of a face of the pedestal to thereby define a service area within the periphery.

### FIELD OF THE INVENTION

This invention relates to a pedestal for semiconductor fabrication equipment.

### BACKGROUND TO THE INVENTION

A semiconductor fabrication equipment is heavy and requires significant connections to utilities. This has led to them being designed with a significant main frame into which equipment facilities or utility connections and distribution (manifold and the like) are generally modular and are connected onto the main frame above floor height. This has been done to enable ready maintenance access to the utility and support parts of the equipment, but it has made the equipment very cumbersome and awkward to install in a manufacturing facility and the connections often become cluttered. A typical example of this, so-called, “one box” system is shown in EP-A-1107288, where particular reference can be made to FIGS. 5, 6,7, 8, 12,13,14,15,16 and 18.

An alternative approach is the so-called “two box” system, where the processing system is split into a main system and a second cabinet, which may be mounted on the floor or wall hung, that contains, for example, the electronics rack, power supplies, electrical distribution etc. There are advantages of ease of access and maintenance in the two box concept, but at the cost of a significantly increased footprint. As all such machinery has to be located in a clean room the footprint of any apparatus significantly affects the construction and maintenance costs of the wafer fabrication facilities.

### SUMMARY OF THE INVENTION

From one aspect the present invention consists in a pedestal for mounting semiconductor fabrication equipment within a clean room, the pedestal including:

a base frame for seating on a waffle slab, and

utility connections, whereby the equipment can readily be connected thereto when positioned on the pedestal and wherein the utility connections are located at the periphery of or across part of a face of the pedestal to thereby define a service area within the periphery.

In a high quality clean room the floor is usually a raised or suspended floor, which is supported on pillars above a perforated structural support known as a waffle slab. This is to allow laminar air flow to pass through the suspended or raised floor, through the waffle slabs and into the return air plenum beneath. It is then recirculated back to the air conditioning equipment. The space between the waffle slab and raised floor (typically 600 mm) is generally not utilised to a significant degree. However, for exceptionally heavy equipment, plinths have been assigned to transfer the load directly to the waffle slab, but most manufacturing equipment is supported on the raised floor.

In the preferred embodiment of the current proposal the pedestal is dimensioned to fit within the space between the waffle slab and the raised or suspended floor so that there is no significant increase in footprint over and above that required by the fabrication equipment, which will in turn have its footprint reduced, because it will not be surrounded by modules of utility connections etc. However, the footprint of the pedestal does not need to be tied to that of the equipment and may be larger or smaller.

It is particularly preferred that the pedestal is in the form of an open frame, such as a box frame, and conveniently it has a base frame spaced from an upper frame and interconnected by legs.

The open frame structure enable access to be obtained through the base frame from the air plenum beneath the waffle slab level and so maintenance can readily be carried out on the utility supplies or connections and indeed access is thereby provided to the underneath of the equipment in a particularly convenient manner.

Preferably the length of the legs is adjustable to enable levelling of the support frame. This levelling will be particularly concerned with rendering the upper support frame level with the floor. Further adjustment may be provided between the support frame and the equipment to enable precise levelling of the equipment so that the force of gravity acts orthogonally through wafers being handled within the equipment.

The upper support frame may define locations for tiles of a suspended or raised floor. The base frame may support a floor and conveniently the floor may be constituted as a drip tray.

The utility connections may be grouped at locations around the frame to allow “drop on” connection of a plurality of processing modules.

The pedestal may conveniently house additional items such as vacuum pumps, coolant circulators, heat exchangers, power supplies, control systems and other ancillary equipment, but these too should be arranged in a manner to allow the service access to be clear and they themselves are preferably readily accessible from the service area.

From another aspect the invention consists in an open frame pedestal for semiconductor fabrication equipment within a clean room, in use the pedestal being seated on a waffle slab and carrying utility connections and/or ancillary equipment.

From a further aspect the invention consists of a clean room for a semiconductor fabrication facility having a waffle slab level, a raised floor above the waffle slab and a pedestal substantially as defined above seated on the waffle slab and being located between the waffle slab and the raised floor.

In addition to the advantages already noted, there are significant economic advantages for the purchaser of the semiconductor equipment. At present, semiconductor equipment tends to be assembled at a single facility and these tend to be located in high wage areas of the world, because the overall complexity of the equipment is such that very highly skilled and knowledgeable engineers have to be used in the assembly and test process. However, the pedestal, as proposed, is relatively easy to fabricate and could be made in much lower technology factories and in cheaper labour cost areas. The pedestal therefore provides an opportunity for a significant reduction in manufacturing cost.

Further the user could install pedestals into their clean room before the equipment is delivered, thus reducing the installation and commissioning time for the equipment. And or the user could maintain the pedestal whilst testing equipment from different sources or when replacing one piece of fabrication equipment by another.

Although the invention has been defined above it is to be understood it includes any inventive combination of the features set out above or in the following description.

### BRIEF DESCRIPTION OF THE DRAWINGS

The invention may be performed in various ways as specific embodiments will now be described by way of example, with reference to the accompanying drawings in which:

FIG. 1 is a schematic view of semiconductor equipment mounted on a pedestal within a clean room; and

FIG. 2 is a more detailed view of an alliterative form of the pedestal.

### DETAILED DESCRIPTION OF THE DRAWINGS

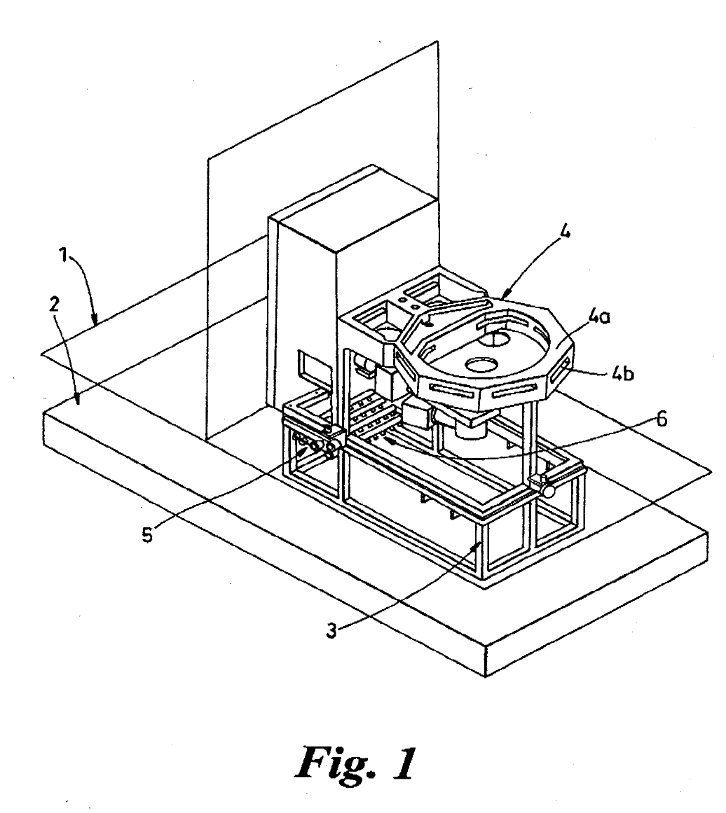

In FIG. 1 a floor 1 is raised above a waffle slab 2 by supports (not shown). An open frame pedestal 3 is seated on the waffle slab and is located in the space between the floor 1 and the waffle slab 2. The pedestal supports semiconductor fabrication equipment, schematically shown at 4. Utility connections (e.g. cooling water, process fluids, extract ducting, electrical supplies etc.) are generally indicated at 5 and may connect to manifolds 6, where more than one connection to a particular service is required. It will be seen that both the connections 5 and the manifolds 6 are readily accessible through the floor and so maintenance can readily be carried out. The manifold 6 essentially extends across part of the upper face of the pedestal 3 and therefore do not restrict access to the service area.

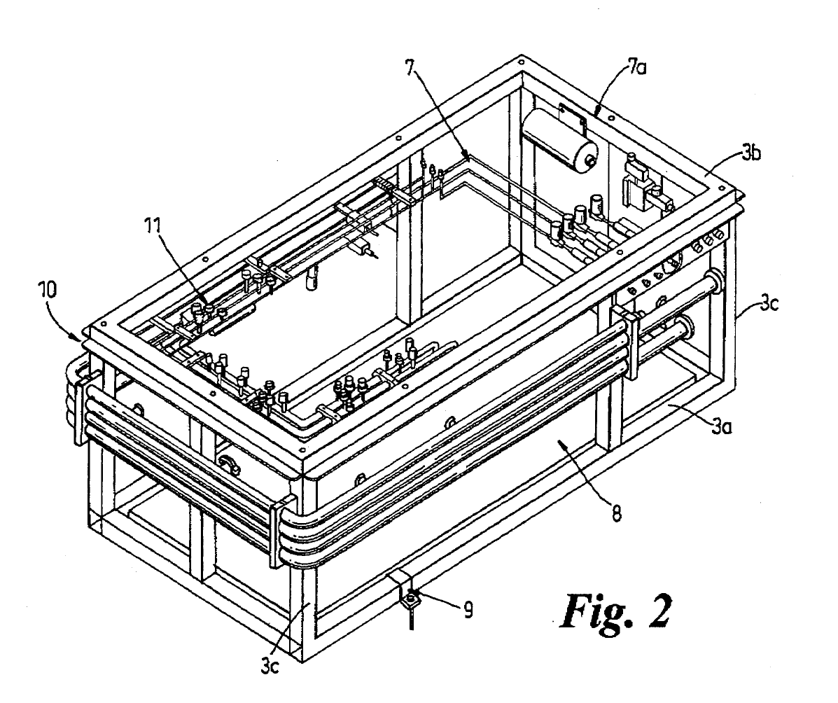

However, the preferred arrangement is shown in FIG. 2, wherein the utilities are essentially arranged around the periphery of the frame 3. Here it will be seen that the liquid, vacuum and gas manifolds and cable distribution, which are generally indicated at 7, extend around the periphery either within the pedestal or on the outside of it. Ancillary equipment, such as shown at 7a, may also be so mounted on the frame 3.

The pedestal 3 itself may be in the form of a box frame having a base frame 3a, an upper support frame 3b and legs 3c. This open structure enhances the ability to suspend pipe work and the like and also increases service access. The use of a base frame 3a has additional advantages. First it can sit anywhere on the waffle slab layer, without fears that the legs 3c may align with holes in the waffle slab layer. Secondly it allows an access aperture through adjusting floor tiles around the pedestal or the base of the system and it is particularly convenient to place a floor 8 within the base frame 3a, which also can function as a drip tray to reduce the likelihood that liquids may become entrained in the laminar air flow or contaminate the waffle slab area.

Anchors 9 are slidably provided on this frame 3a so that their position can be adjusted to pick up the beams that support the waffle slab layer.

The support frame 3b, on which the equipment 4 rests (see FIG. 1), may have outer peripheral flanges 10 for supporting tiles of the raised floor 1.

The equipment 4 shown in FIG. 1 is in fact incomplete, in that it simply shows the main central unit which would contain the wafer handling equipment, the control equipment etc. The customer's chosen process modules would then be distributed around the central unit 4a to access wafers through slot valves 4b. Conveniently the service connections for these modules can be grouped at appropriate locations around the frame 3 aligned with the locations of the modules attached about the central unit 4a. Such an array of connections is illustrated at 11.

We claim:

1. A pedestal (3) for mounting semiconductor fabrication equipment (4) within a clean room, the pedestal including:
a base frame (3a) for seating on a waffle slab (2), and
utility connections (5), whereby the equipment can readily be connected thereto when positioned on the pedestal and wherein the utility connections are located at the periphery of or across part of a face of the pedestal to thereby define a service area within the periphery.

2. A pedestal as claimed in claim 1 wherein the pedestal (3) is in the form of a box frame formed by an upper support frame (3b) spaced from the base frame (3a), the upper and base frames being interconnected by legs (3c).

3. A pedestal as claimed in claim 2 wherein the length of the legs (3c) is adjustable to enable levelling of the support frame (3b).

4. A pedestal as claimed in claim 2 wherein the support frame (3b) defines locations for tiles of a suspended floor (1).

5. A pedestal as claimed in claim 2 wherein the base frame (3a) supports a floor (1).

6. A pedestal as claimed in claim 1 wherein the utility connections (5) are grouped at locations around the base frame (3a) aligned with the locations of a plurality of processing modules (4).

7. An open frame pedestal (3) for semiconductor fabrication equipment (4) within a clean room, in use the pedestal being seated on a waffle slab (2) and carrying utility connections (5) and/or ancillary equipment (7a).

8. A clean room for a semiconductor fabrication facility having a waffle slab (2) level, a raised floor (1) above the waffle slab and a pedestal (3) as claimed in claim 1 seated on the waffle slab and being located between the waffle slab and the raised floor.
